(19) United States
(12) Patent Application Publication
(10) Pub. No.: US 2008/0137978 A1
(43) Pub. Date: Jun. 12, 2008

(54) Method And Apparatus For Reducing Motion Blur In An Image

(76) Inventor: Guoyi Fu, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/608,099

(22) Filed: Dec. 7, 2006

(51) Int. Cl. G06K 9/40

(52) U.S. Cl. 382/255

(57) ABSTRACT

A method and apparatus for reducing motion blur in a motion blurred image are provided. The method includes blurring a guess image based on the motion blurred image as a function of blur parameters of the motion blurred image. The blurred guess image is compared with the motion blurred image and an error image is generated. The error image is blurred and pixels in the blurred error image are weighted based on the steepness of edges proximal to corresponding pixels in the motion blurred image. The blurred and weighted error image and the guess image are combined thereby to update the guess image and correct for motion blur.

### FIELD OF THE INVENTION

The present invention relates generally to image processing, and more particularly to a method and apparatus for reducing motion blur in an image.

### BACKGROUND OF THE INVENTION

Motion blur is a well-known problem in the imaging art that may occur during image capture using digital video or still-photo cameras. Motion blur is caused by camera motion, such as vibration, during the image capture process. Historically, motion blur could only be corrected when a priori measurements estimating actual camera motion were available. As will be appreciated, such a priori measurements typically were not available and as a result, other techniques were developed to correct for motion blur in captured images.

For example, methods for estimating camera motion parameters (i.e. parameters representing the path of the image capture device during exposure) based on attributes intrinsic to a captured motion blurred image are disclosed in co-pending U.S. patent application Ser. No. 10/827,394 entitled, “MOTION BLUR CORRECTION”, assigned to the assignee of the present application, the content of which is incorporated herein by reference. In these methods, once the camera motion parameters are estimated, blur correction is conducted using the estimated camera motion parameters to reverse the effects of camera motion and thereby blur correct the image.

Methods for reversing the effects of camera motion to blur correct a motion blurred image are known. For example, the publication entitled “Iterative Methods for Image Deblurring” authored by Biemond et al. (Proceedings of the IEEE, Vol. 78, No. 5, May 1990), discloses an inverse filter technique to reverse the effects of camera motion and correct for blur in a captured image based on estimated camera motion parameters. During this technique, the inverse of a motion blur filter that is constructed according to estimated camera motion parameters is applied directly to the blurred image.

Unfortunately, the Biemond et al. blur correction technique suffers from disadvantages. Convolving the blurred image with the inverse of the motion blur filter can lead to excessive noise amplification. Furthermore, with reference to the restoration equation disclosed by Biemond et al., the error contributing term, which has positive spikes at integer multiples of the blurring distance, is amplified when convolved with high contrast structures such as edges in the blurred image, leading to undesirable ringing. Ringing is the appearance of haloes and/or rings near sharp edges in the image and is associated with the fact that de-blurring an image is an ill-conditioned inverse problem. The Biemond et al. publication discusses reducing the ringing effect based on the local edge content of the image, so as to regulate the edgy regions less strongly and suppress noise amplification in regions that are sufficiently smooth. However, with this approach, ringing noise may still remain in local regions containing edges.

Various techniques that use an iterative approach to generate blur corrected images have also been proposed. Typically during these iterative techniques, a guess image is motion blurred using the estimated camera motion parameters and the guess image is updated based on the differences between the motion blurred guess image and the captured blurred image. This process is performed iteratively a predetermined number of times or until the guess image is sufficiently blur corrected. Because the camera motion parameters are estimated, blur in the guess image is reduced during the iterative process as the error between the motion blurred guess image and the captured blurred image decreases to zero. The above iterative problem can be formulated according to Equation (1) as follows:

I(x,y)=h(x,y) [symbol] O(x,y)+n(x,y) (1)

where:

I(x,y) is the captured motion blurred image;

h(x,y) is the motion blurring or “point spread” function;

O(x,y) is an unblurred image corresponding to the motion blurred image I(x,y);

n(x,y) is noise; and

A [symbol] B denotes the convolution of A and B.

As will be appreciated from the above, the goal of image blur correction is to produce an estimate (restored) image O′(x,y) of the unblurred image O(x,y), given the captured blurred image I(x,y). In Equation (1), the point spread function h(x,y) is assumed to be known from the estimated camera motion parameters. If noise is ignored, the error E(x,y) between the restored image O′(x,y), and the unblurred image O(x,y), can be defined by Equation (2) as follows:

E(x,y)=I(x,y)−h(x,y) [symbol] O′(x,y) (2)

During each iteration of motion blur correction, the error image is blurred and weighted with a constant step size parameter α, and then combined with the previous estimate (restored) image O′(x,y) of the unblurred image thereby to update the estimate.

While iterative motion blur correction procedures provide improvements, excessive ringing and noise can still be problematic. These problems are due to the ill-conditioned nature of the motion blur correction problem, motion blur parameter estimation errors, and noise amplification during deconvolution. Furthermore, because in any practical implementation the number of corrective iterations is limited due to performance concerns, convergence to an acceptable solution is often difficult to achieve.

Other iterative blur correction methods have been proposed. For example, U.S. Patent Application Publication No. 2005/0074152 to Lewin et al. discloses a method for reconstructing and deblurring magnetic resonance images. During the method, sampled k-space data is distributed on a rectilinear k-space grid and the distributed data is inverse Fourier transformed. A selected portion of the inverse transformed data is set to zero and the zeroed and remaining portions of the inverse transformed data are Fourier transformed. The Fourier transformed data is replaced with the distributed k-space data at corresponding points of the rectilinear k-space grid to produce a grid of updated data. The updated data is then inverse Fourier transformed. The procedure, starting with the inverse Fourier transformation of the distributed data, is iteratively applied until a difference between the inverse Fourier transformed updated data and the inverse Fourier transformed distributed data is sufficiently small.

U.S. Patent Application Publication No. 2005/0031221 to Ludwig discloses a method for correcting for the effects of lens misfocus in photographs, video, and other types of captured images. During the method, arbitrary fractional Fourier transform powers are computed using a transform operator. The fractional Fourier transform parameters are adjusted to maximize the sharp edge content of the resulting correcting image. The power and scale factors of the fractional Fourier transform may be set and adjusted as necessary based on a step direction and size control element, which initially sets the power to an ideal initial value of 0 and then deviates slightly in either direction from the initial value. The resulting image data may be presented to an edge detector which transforms edge information into a scalar-value measure of the relative degree of the sharpness of the edges so as to measure image sharpness.

U.S. Pat. No. 4,298,944 to Stoub et al. discloses a method for correcting for distortion caused by scintillation cameras or similar image-forming apparatus. Orthogonal line pattern test data is obtained in an initial off-line test phase in order to calculate spatial distortion correction factors. The spatial distortion correction factors are modified in accordance with image field test data and used to correct image event data output signals during on-line operation. Calculated spatial distortion correction factors are iteratively modified using the gradient of effective image event density of the corrected image event data on a per unit basis. Each of the iterative modifications comprises an evaluation of the gradient over respective sizes of image areas.

U.S. Pat. No. 4,047,968 to Carrington et al. discloses an iterative image restoration device for use with an optical system such as a camera. The restoration device iteratively determines, for each point in a viewed image, a factor that minimizes noise and distortion at the point. In particular, the factor is iteratively determined using both a division operation of an optical member (i.e. a lens) response function transform, and a resonance function transform.

U.S. Pat. No. 5,561,661 to Avinash discloses a method and apparatus for restoring a signal such as that obtained from a microscope by estimating an ideal signal over a selected number of iterations. During each iteration, spatial frequency band limits are used to constrain the frequency domain estimate of a response function in order to facilitate the processing of signals in a rapid manner. The step size of the error term is based on the frequency response of the previous estimate.

U.S. Patent Application Publication No. 2005/0100241 to Kong et al. discloses a method for reducing ringing artifacts in images based on classification of local features in a decompressed image. The decompressed image is expected to have blocking artifacts caused by independent quantization of discrete cosine transformation (DCT) coefficients of the compressed image. Ringing artifacts are also possible along edges in the decompressed image. During the method, the blocking artifacts are removed by filtering detected block boundaries in the decompressed image. If a blocking artifact is detected, a one-dimensional low-pass smoothing filter is adaptively applied to pixels along block boundaries such that filter size corresponds to the gradients at the block boundaries. Pixels with large gradient values (i.e. edge pixels) are excluded from the operation to avoid blurred edges or textures. The blocked classifications include “smooth”, “textured”, and “edge” blocks according to a variance value or an “edge map”.

U.S. Patent Application Publication No. 2005/0147313 to Gorinevsky discloses an iterative method for deblurring an image using a systolic array processor. Data is sequentially exchanged between processing logic blocks by interconnecting each processing logic block with a predefined number of adjacent processing logic blocks, and then uploading the deblurred image. The processing logic blocks respectively provide an iterative update of the blurred image through feedback of the blurred image prediction error using the current deblurred image and the past deblurred image estimate. According to one embodiment, a Landweber method incorporating high-frequency regularization is used to address iterative update convergence issues.

U.S. Patent Application Publication No. 2006/0045378 to Behiels discloses a method of correcting artifacts in digital signals representing radiographic images. In order to digitize a complete line of computed radiography images plates, several microlens arrays are assembled into a larger microlens having a width that is large enough to digitize a line of imaging plates of commonly used dimensions. Artifacts at the joints of the microlens arrays are visible. The joints representing artifacts are detected using edge detectors and extracted from the image signal. The extracted artifacts are then used to obtain a new artifact profile signal via an amplitude deformation technique which applies a scale factor. In each iteration step, weight factors are taken into account. The weight factor in a current iteration step is dependent upon the variation of a corrected image signal obtained with the scale factor obtained in a previous iteration step.

In the publication entitled “Adaptive Landweber Method To Deblur Images” authored by L. Liang and R. M. Mersereau (IEEE Signal Processing Letters, 10(5): 129-132, 2003), an iterative method to blur correct images is disclosed wherein the contribution of the blurred error image is adapted by using an iteration-adaptive step size a for weighting the blurred error image so that the contribution of the blurred error image is progressively reduced at each iteration. Unfortunately, significant ringing artifacts are still caused in the vicinity of steep image edges, particularly during the first several iterations when step size α, and therefore the contribution of the blurred error image, is large. Furthermore, because step size α is progressively reduced, the overall convergence rate is reduced.

While iterative methods such as those described above provide some advantages over direct reversal of blur using motion blur filters, it will be appreciated that improvements are desired for reducing noise amplification and ringing. It is therefore an object of the present invention to provide a novel method and apparatus for reducing motion blur in an image.

### SUMMARY OF THE INVENTION

In accordance with one aspect, there is provided a method of reducing motion blur in a motion blurred image comprising:
blurring a guess image based on the motion blurred image as a function of blur parameters of the motion blurred image;
comparing the blurred guess image with the motion blurred image and generating an error image;
blurring the error image;
weighting pixels in the blurred error image based on the steepness of edges proximal to corresponding pixels in the motion blurred image; and
combining the blurred and weighted error image and the guess image thereby to update the guess image and correct for motion blur.

In one embodiment, the weighting comprises constructing a weighting image having pixel values that are based on the steepness of edges proximal to corresponding pixels in the motion blurred image. The weighting image is then combined with the blurred error image to form a blurred and weighted error image. The construction of the weighting image may comprise, for each pixel in the motion blurred image, identifying a neighborhood of pixels; calculating a luminance gradient of pixels within each neighborhood; and normalizing each luminance gradient with respect to its neighborhood. Each pixel in the weighting image is the normalized luminance gradient corresponding to each pixel in the motion blurred image.

In accordance with another aspect, there is provided an apparatus for reducing motion blur in a motion blurred image, the apparatus comprising:
a guess image blurring module blurring a guess image based on the motion blurred image as a function of blur parameters of the motion blurred image;
a comparator comparing the blurred guess image with the motion blurred image and generating an error image;
an error image blurring module blurring the error image;
a weighting module weighting pixels in the blurred error image based on the steepness of edges proximal to corresponding pixels in the motion blurred image; and
an image combiner combining the blurred and weighted error image and the guess image thereby to update the guess image and correct for motion blur.

In accordance with yet another aspect, there is provided a computer readable medium embodying a computer program for reducing motion blur in a motion blurred image, the computer program comprising:
computer program code blurring a guess image based on the motion blurred image as a function of blur parameters of the motion blurred image;
computer program code comparing the blurred guess image with the motion blurred image and generating an error image;
computer program code blurring the error image;
computer program code weighting pixels in the blurred error image based on the steepness of edges proximal to corresponding pixels in the motion blurred image; and
computer program code combining the blurred and weighted error image and the guess image thereby to update the guess image and correct for motion blur.

The blur reducing method and apparatus provide several advantages. In particular, as weighting is based on the steepness of edges proximal to corresponding pixels in the motion blurred image, morphologically-adapted conversion during the iterative blur correction is achieved. For example, portions of the captured image in the middle of steep transitions rapidly reach convergence due to their relatively high weighting, while more homogeneous portions of the captured image in the vicinity of steep transitions reach convergence more slowly. An efficient compromise between speed of processing and reduction of ringing is thereby achieved. The addition of a regularization term suppresses noise amplification during deconvolution and reduces ringing artifacts.

### BRIEF DESCRIPTION OF THE DRAWINGS

Embodiments will now be described more fully with reference to the accompanying drawings, in which:

FIG. 1 is a flowchart showing steps performed during reduction of motion blur in a captured image;

FIG. 2 is a flowchart illustrating the steps for correcting motion blur in the captured image using the estimated motion blur parameters;

FIG. 3 is a horizontal blurred step image illustrating the effect of ringing during correction for motion blur in a captured image;

FIG. 4 is a set of space-luminance profiles illustrating the ringing effect contributed by correction terms during a first iteration of motion blur correction of the step image of FIG. 3;

FIG. 5 is a set of space-luminance profiles illustrating the ringing effect contributed by correction terms during a first iteration of motion blur correction of the step image of FIG. 3 using weighting;

FIG. 6 is a set of two superimposed space-luminance profiles illustrating the amount of ringing in updated guess images obtained with and without weighting, respectively; and

FIGS. 7a-7h is a set of images illustrating the ringing effect contributed by correction terms during motion blur correction after a number of iterations, both with and without weighting.

### DETAILED DESCRIPTION OF THE EMBODIMENTS

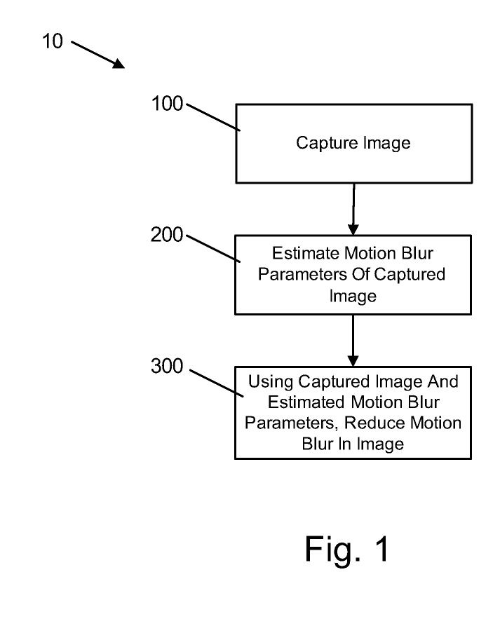

In the following description, methods, apparatuses and computer readable media embodying computer programs for reducing motion blur in an image are disclosed. The methods and apparatuses may be embodied in a software application comprising computer executable instructions executed by a processing unit including but not limited to a personal computer, a digital image or video capture device such as for example a digital camera, camcorder or electronic device with video capabilities, or other computing system environment. The software application may run as a stand-alone digital video tool, an embedded function or may be incorporated into other available digital image/video applications to provide enhanced functionality to those digital image/video applications. The software application may comprise program modules including routines, programs, object components, data structures etc. and may be embodied as computer readable program code stored on a computer readable medium. The computer readable medium is any data storage device that can store data, which can thereafter be read by a computer system. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion. Embodiments will now be described with reference to FIGS. 1 to 6.

Turning now to FIG. 1, a method of reducing motion blur in an image captured by an image capture device such as for example, a digital camera, digital video camera or the like is shown. During the method, when a motion blurred image I(x,y) is captured (step 100) its Y-channel luminance image is extracted, and the motion blur parameters are estimated (step 200). The estimated motion blur parameters are then used to reduce motion blur in the captured image (step 300) thereby to generate a motion blur corrected image.

The motion blur parameters may be estimated using well-known techniques. According to one technique, input data from a gyro-based system in the image capture device is obtained during exposure, and processed to calculate an estimate of the motion blur parameters representing the path of image capture device motion during exposure. The estimated motion blur parameters may comprise a motion blur direction and a motion blur extent, or represent more complex motion. For example, the motion blur parameters may comprise the extents and directions of multiple incremental linear movements of the image capture device obtained by periodically sampling the input data during the exposure time. The multiple incremental linear movements in aggregate represent the motion path traversed by the image capture device during the exposure time.

According to an alternative technique for estimating motion blur parameters, blind motion estimation may be conducted using attributes inherent to the captured motion blurred image. One example of such a technique is described in aforementioned U.S. patent application Ser. No. 10/827,394, the content of which has been incorporated herein by reference.

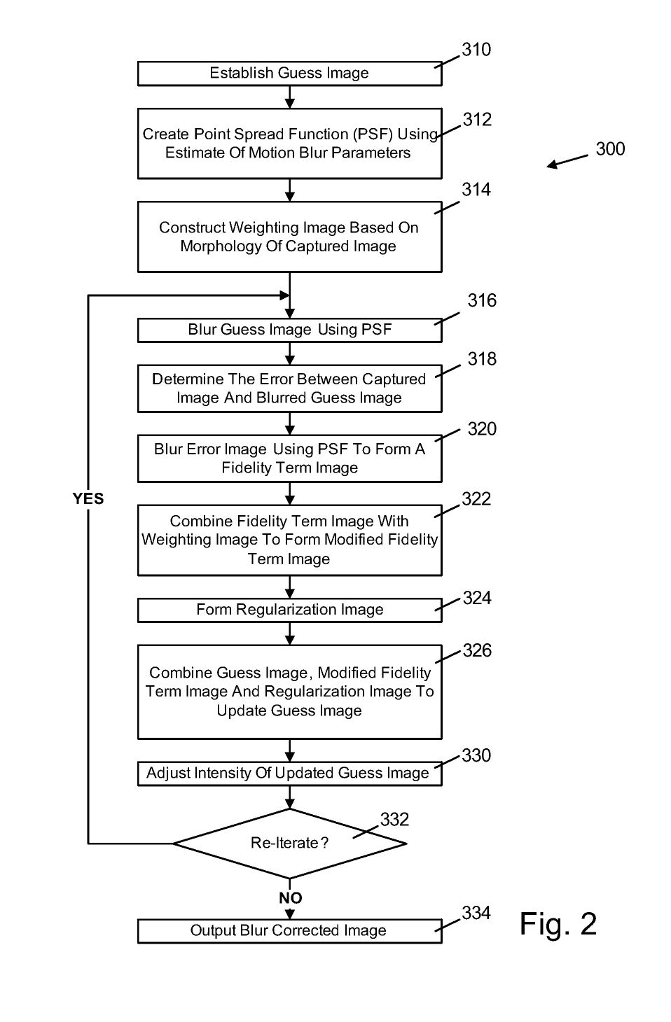

FIG. 2 is a flowchart showing the steps performed during generation of the motion blur corrected image using the estimated motion blur parameters of the captured image at step 300. Initially, an initial guess image O₀(x,y) equal to the captured image I(x,y) is established (step 310), as expressed by Equation (3) below:

Oₙ(x,y)=I(x,y) (3)

where:

n is the iteration count, in this case zero (0) as it is the initial guess image.

A point spread function (PSF) or “motion blur filter” h(x,y) is then created based on the estimated motion blur parameters (step 312). Methods for creating the PSF h(x,y) particularly where motion during image capture is assumed to have occurred linearly and at a constant velocity, are well-known and will not be described in further detail herein. Following creation of the PSF h(x,y), a weighting image α(x,y) is constructed based on the morphology of the captured image (step 314).

During construction of the weighting image α(x,y), a normalized morphology gradient image g(x,y) is constructed by determining, for each pixel in the captured image, the edge content within a local neighborhood. The local neighborhood is defined by a structural element B that is based on positive-value elements of the PSF h(x,y), as expressed in Equations (4) to (6) below:

$$\begin{matrix}B = h ( x , y ) > 0 \\ where \text{:} & ( 4 ) \\ B = [ \begin{matrix}{B}_{1 , 1} & & ⋯ & & {B}_{1 , N} \\ & ⋯ & & & \\ & & {B}_{j , k} & & \\ & & & ⋯ & \\ {B}_{M , 1} & & ⋯ & & {B}_{M , N}\end{matrix} ] ; & ( 5 ) \\ {B}_{j , k} = \{ \begin{matrix}1 if h ( j , k ) > 0 \\ 0 if h ( j , k ) = 0\end{matrix} ; and & ( 6 )\end{matrix}$$

M and N are the height and width of h(x,y).

It will be appreciated that where motion is linear and at a constant-velocity, the structural element B is a straight line that extends in a direction equal to the determined blur direction and to an extent equal to the determined blur extent. For example, if the determined blur direction was equal to 45 degrees and the determined blur extent was equal to three (3) pixels, the PSF h(x,y) and corresponding structural element B would be expressed by Equations (7) and (8) below:

$$\begin{matrix}h ( x , y ) = \vert \begin{matrix}0 & 0 & 0.33 \\ 0 & 0.33 & 0 \\ 0.33 & 0 & 0\end{matrix} \vert & ( 7 ) \\ B = \vert \begin{matrix}0 & 0 & 1 \\ 0 & 1 & 0 \\ 1 & 0 & 0\end{matrix} \vert & ( 8 )\end{matrix}$$

As another example, if the determined blur direction was equal to 90 degrees and the determined blur extent was equal to three (3) pixels, the PSF h(x,y) and corresponding structural element B would be expressed by Equations (9) and (10) below:

$$\begin{matrix}h ( x , y ) = \vert \begin{matrix}0.33 \\ 0.33 \\ 0.33\end{matrix} \vert & ( 9 ) \\ B = \vert \begin{matrix}1 \\ 1 \\ 1\end{matrix} \vert & ( 10 )\end{matrix}$$

The pixel value at a position (x,y) in the normalized morphology gradient image g(x,y) is expressed by Equations (11) to (13) below:

$$\begin{matrix}g ( x , y ) = \frac{imdilate ( I , B ) - imerode ( I , B )}{imdilate ( imdilate ( I , B ) - imerode ( I , B ) , B )} \\ where \text{:} & ( 11 ) \\ imdilate ( I , B ) = imdilate ( I , B ) ( x , y ) ; \\ which can be expressed as \text{:} \\ {max}_{{B}_{j , k} = 1} ( I ( x - j , y - k ) ) ; or {max}_{B} ( I ) & ( 12 ) \\ imerode ( I , B ) = imerode ( I , B ) ( x , y ) ; \\ which can be expressed as \text{:} \\ {min}_{{B}_{j , k} = 1} ( I ( x - j , y - k ) ) ; or {min}_{B} ( I ) & ( 13 )\end{matrix}$$

and I is the motion blurred image.

The morphological dilation operation imdilate(I,B) on the motion blurred image I yields the maximum

$${max}_{B} ( I )$$

of the luminance values of all pixels within each pixel's neighborhood defined by structural element B. The morphological erosion operation imerode(I,B) on the motion blurred image I yields the minimum

$${min}_{B} ( I )$$

of the luminance values of all pixels within each pixel's neighborhood defined by structural element B.

As will be appreciated, the normalized morphology gradient image g(x,y) is the image morphology gradient normalized by the local gradient maximum. As a result, each pixel in the normalized morphology gradient image g(x,y) has a value that falls between zero (0) and one (1), inclusive.

Following construction of the normalized morphology gradient image g(x,y), the weighting image α(x,y) is constructed by scaling the normalized morphology gradient image g(x,y) by a value β representing a maximum step size, as expressed by Equation (14) below:

α(x,y)=β·g(x,y) (14)

where:
β is a parameter to control the speed of the convergence. β is in the set of [0,2].

As will be appreciated, the resultant weighting image α(x,y) includes pixels with luminance values that are based on the steepness of edges proximal to corresponding pixels in the motion blurred image.

Following construction of the weighting image α(x,y), the guess image Oₙ(x,y) is blurred using the PSF h(x,y) (step 316). An error image is then calculated by finding the difference between the blurred guess image and the captured input image I(x,y) (step 318). The error image is then convolved with a “flipped” PSF h(−x,−y) to form a blurred error, or “fidelity term” image F (step 320), as expressed by Equation (15) below:

F=h*(x,y) [symbol] (I−Oₙ₋₁ [symbol] h) (15)

where:

h*(x,y)=h(−x,−y)

The weighting image α(x,y) constructed at step 314 is then combined with the fidelity term image F to form a blurred and weighted error or “modified fidelity term” image MF (step 322) as expressed by Equation (16) below:

MF=α(x,y)·h* [symbol] (I−Oₙ₋₁ [symbol] h) (16)

A regularization image L is then formed (step 324). During formation of the regularization image L, a regularization term is obtained by calculating horizontal and vertical edge images Oₕ and Oᵥ respectively, based on the guess image Oₙ₋₁, as expressed by Equations (17) and (18) below:

Oₕ=Oₙ₋₁ [symbol] D*^{T} (18)

Oᵥ=Oₙ₋₁ [symbol] D* (18)

where:

$$D = \frac{1}{4} [ \begin{matrix}- 1 & - 2 & - 1 \\ 0 & 0 & 0 \\ 1 & 2 & 1\end{matrix} ] ,$$

a Sobel derivative operator; and

D*(x,y)=D(−x,−y).

The Sobel derivative operator referred to above is a known high-pass filter suitable for use in determining the edge response of an image.

The horizontal and vertical edge images Oₕ and Oᵥ are then normalized. To achieve p-norm regularization and thereby control the extent of sharpening or smoothing, the manner of normalizing is selectable. In particular, a variable p having a value between one (1) and two (2) is selected and then used for calculating the normalized horizontal and vertical edge images according to the following routine:

$$If p not = 2$$

$$If p = 1$$

$${O}_{h} ( x , y ) = \frac{{O}_{h} ( x , y )}{\vert {O}_{h} ( x , y ) \vert + \vert {O}_{v} ( x , y ) \vert}$$

$${O}_{v} ( x , y ) = \frac{{O}_{v} ( x , y )}{\vert {O}_{h} ( x , y ) \vert + \vert {O}_{v} ( x , y ) \vert}$$

$$Else$$

$${O}_{h} ( x , y ) = \frac{{pO}_{h} ( x , y )}{{\vert {O}_{h} ( x , y ) \vert}^{2 - p} + {\vert {O}_{v} ( x , y ) \vert}^{2 - p}}$$

$${O}_{v} ( x , y ) = \frac{{pO}_{v} ( x , y )}{{\vert {O}_{h} ( x , y ) \vert}^{2 - p} + {\vert {O}_{v} ( x , y ) \vert}^{2 - p}}$$

$$End If$$

$$End If$$

It will be understood that a p value equal to 1 results in a normalization consistent with total variation regularization, whereas a p value equal to 2 results in a normalization consistent with Tikhonov-Miller regularization. A p-value between one (1) and two (2) results in a regularization strength between those of total variation regularization and Tikhonov-Miller regularization, which, in some cases, helps to avoid over-sharp or over-smooth results. The p value may be user selectable or set to a default value.

Where blur parameter estimation has determined that motion of the image capture device during image capture was linear and at a constant velocity, the normalized horizontal and vertical edge images Oₕ and Oᵥ are then weighted according to the estimated linear direction of motion blur, and summed to form an orientation-selective regularization image L, as expressed by Equation (19) below:

L=cos(θₘ)·(Oₕ [symbol] D^{T})+sin(θₘ)·(Oᵥ [symbol] D) (19)

Where blur parameter estimation has determined that motion of the image capture device during image capture was not both linear and at a constant velocity, the regularization image L is formed without the directional weighting, as expressed by Equation (20) below:

L=(Oₕ [symbol] D^{T})+(Oᵥ [symbol] D) (20)

Following formation of the regularization image L, an updated guess image Oₙ is generated by combining the guess image, the modified fidelity term image MF of Equation (16) and the regularization image L of Equation (19) (or Equation (20)) (step 326), as expressed by Equation (21) below:

Oₙ=Oₙ₋₁MF−ηL (21)

where:

η is the regularization parameter.

It will be understood that the regularization parameter η is selected based on the amount of regularization that is desired to sufficiently reduce ringing artifacts in the updated guess image.

The intensities of the pixels in the updated guess image Oₙ are then adjusted as necessary to fall between 0 and 255, inclusive (step 330), according to Equation (22) below:

$${O}_{n} ( x , y ) = \{ \begin{matrix}0 ; {O}_{n} ( x , y ) < 0 \\ 255 ; {O}_{n} ( x , y ) > 255 \\ {O}_{n} ( x , y ) ; otherwise\end{matrix} \qquad ( 22 )$$

After the intensities of the pixels have been adjusted as necessary, it is then determined at step 332 whether to output the updated guess image Oₙ as the motion blur corrected image, or to revert back to step 316. The decision as to whether to continue iterating in this embodiment, is based on the number of iterations having exceeded a threshold number. If no more iterations are to be conducted, then the updated guess image Oₙ is output as the motion blur corrected image (step 334).

As will be appreciated, the fidelity term image F is modified by the weighting image α(x,y) such that the contribution of particular pixels in the fidelity term image F during the combining at step 326 is adapted to the morphology of the captured image. The weighting image α(x,y) therefore functions as a morphologically-adapted step size that tunes the contribution of the fidelity term image F to the morphology of the captured image. More particularly, rapid conversion is achieved for image areas that are in the middle of steep transitions while slower, more regulated conversion is undertaken in homogeneous areas in the vicinity of steep transitions in order to suppress ringing. As a result, a beneficial balance between performance and ringing suppression is achieved.

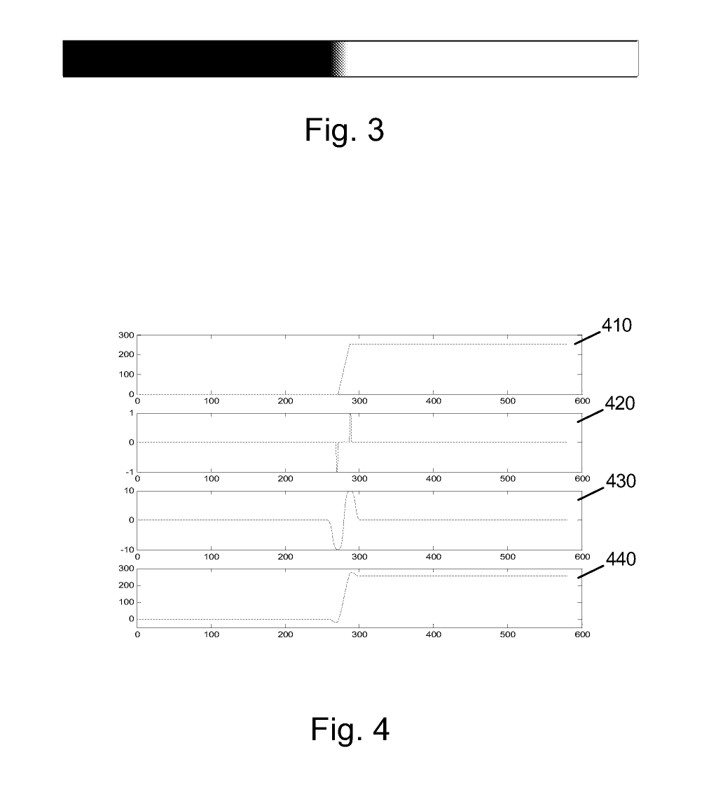

The effect of the weighting image α(x,y) for adapting the contribution of the fidelity term image F to the morphology of the captured image is shown by way of example in FIGS. 3 to 6. FIG. 3 shows a simple, motion blurred, fifteen (15) pixel horizontal step image captured by an image capture device. The initial guess image is the captured motion blurred image. FIG. 4 shows a set of luminance-space profiles illustrating the ringing contributed by the correction term images (i.e. an unmodified fidelity image and a regularization image) during the first iteration of motion blur correction of the initial guess image, according to known methods for blur correction. In particular, profile 410 corresponds to the initial guess image Oₙ(x,y), profile 420 corresponds to the regularization image L, and profile 430 corresponds to the unmodified fidelity term image F. Profile 440 corresponds to the updated guess image resulting from the combination of the initial guess image, the unmodified fidelity term image F and the regularization image L.

It can be seen particularly in the portions of updated guess image profile 440 identified by the circles that significant ringing artifacts are present in the vicinity of the steep transitions. The ringing artifacts are primarily caused by the contribution of the unmodified fidelity term image F (profile 430).

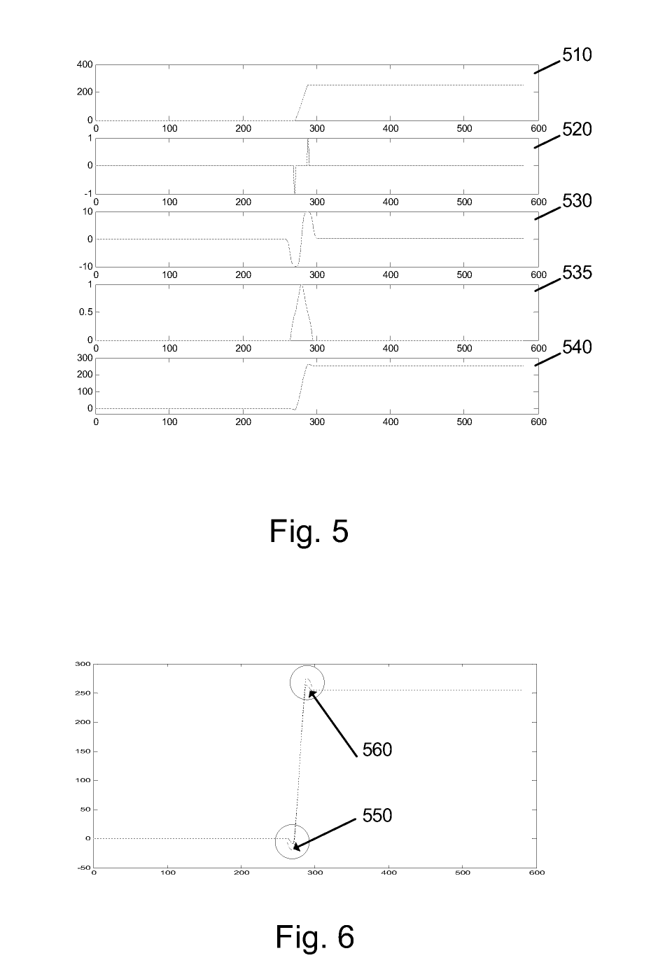

FIG. 5 shows a set of luminance-space profiles illustrating the ringing effect contributed by the correction term images during the first iteration of motion blur correction of the initial guess image of FIG. 3, wherein the weighting image α(x,y) is combined with the fidelity term image F. In particular, profile 510 corresponds to the initial guess image Oₙ(x,y), profile 520 corresponds to the regularization image L, profile 530 corresponds to the unmodified fidelity term image F, and profile 530 corresponds to the normalized morphology gradient image g(x,y) used as the basis for the weighting image α(x,y). Profile 540 corresponds to the profile of the updated guess image that is the combination of the initial guess image Oₙ(x,y), a modified fidelity image MF (i.e. a combination of the fidelity term image F and the weighting image α(x,y)), and the regularization image L.

It will be apparent that ringing in the vicinity of the steep transitions is reduced due to weighting image α(x,y). This is better illustrated in FIG. 6, which shows the updated guess image profiles 440 and 540. The ringing shown in portion 560 of profile 540 is clearly smaller than the ringing portion 550 of profile 440, due to the contribution of weighting image α(x,y).

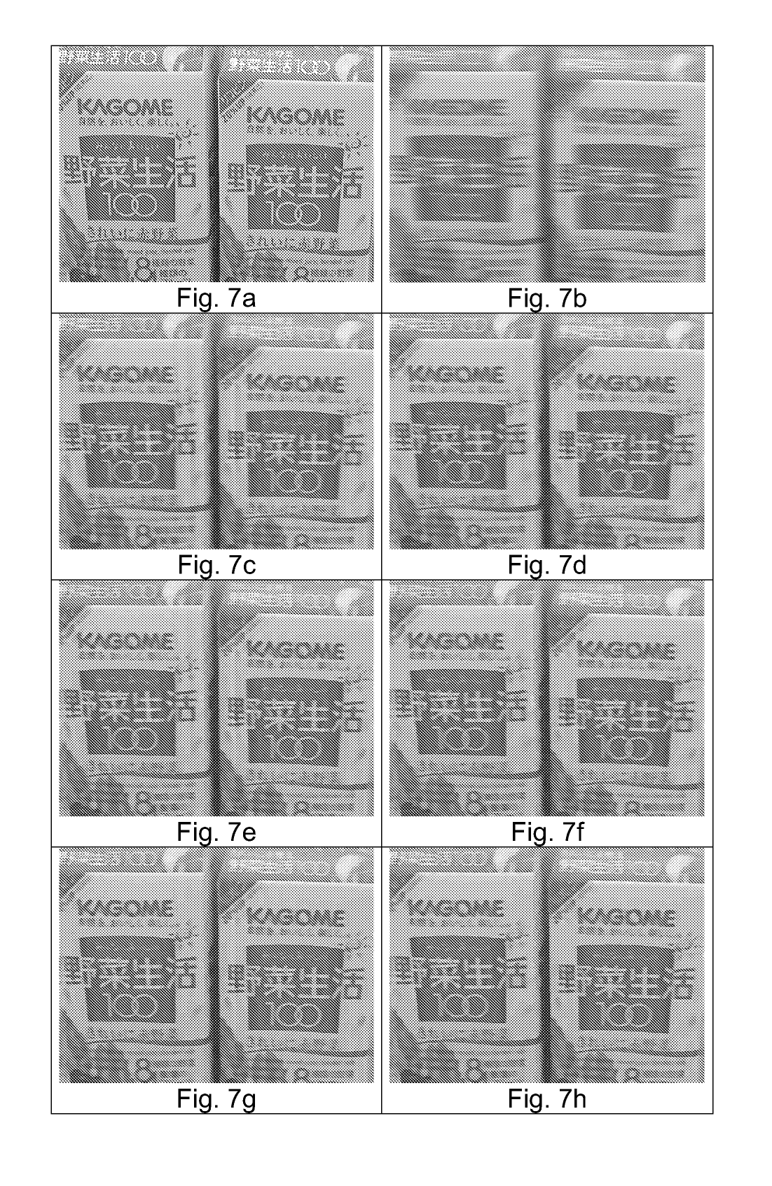

FIGS. 7a-7h is a set of images illustrating the ringing effect contributed by correction terms during motion blur correction after a number of iterations, both with and without weighting. FIG. 7a shows an ideal image with no blur. FIG. 7b shows a motion blurred image I, which is the ideal image of FIG. 7a having been deliberately blurred horizontally by 31 pixels. FIGS. 7c, 7e and 7g show the motion blur corrected image based on the motion blurred image of FIG. 7b after 30, 50 and 100 iterations, respectively, of motion blur correction that does not employ the weighting image α(x,y). In contrast, FIGS. 7d, 7f and 7h show the motion blur corrected image after 30, 50 and 100 iterations, respectively, of motion blur correction that employs the weighting image α(x,y). It can be seen that weighting image α(x,y) improves ringing suppression, particularly in the areas of steep transitions.

It will be appreciated that regularization functions to suppresses noise amplification during deconvolution, and also reduce ringing artifacts where possible. In the case of linear, constant-velocity motion, the directional weighting of horizontal and vertical edges when forming the regularization term L reduces undesirable blurring of edges in non-motion directions during blur correction.

The blur correction method including p-norm regularization, where p>1, can be computationally complex and expensive. Therefore, when considering performance (i.e. speed), it may be advantageous to limit the p-norm p value to 1. While performance is increased as a result, only in relatively rare cases is motion blur correction quality significantly degraded. To further enhance performance, p-norm regularization may be skipped during some iterations or omitted entirely. Of course skipping or omitting p-norm regularization results in a trade-off between the overall speed of motion blur correction and the amount of desired/required noise removal and ringing reduction. For example, where the input image has a high signal-to-noise ratio (i.e. 30 dB or greater, for example), there may be no need to perform any p-norm regularization.

It will be understood that while the steps 316 to 330 are described as being executed a threshold number of times, other criteria for limiting the number of iterations may be used in concert or as alternatives. For example, the iteration process may proceed until the magnitude of the error between the captured image and a blurred guess image falls below a threshold level, or fails to change in a subsequent iteration by more than a threshold amount. The number of iterations may alternatively be based on other criteria.

It will be apparent to one of ordinary skill in the art that as alternatives to the Sobel derivative operator for obtaining the horizontal and vertical edge images, other suitable edge detectors/high-pass filters may be employed.

It is known that in order to simplify motion blur correction, blur-causing motion is typically assumed to be linear and at a constant velocity. However, because motion blur correction depends heavily on an initial estimation of motion blur extent and direction, inaccurate estimations of motion blur extent and direction can result in unsatisfactory motion blur correction results. Advantageously, the above-described methods may be used with a point spread function (PSF) that represents more complex image capture device motion. In such cases, it should be noted that the orientation-selective regularization image expressed by Equation (19) is best suited to situations of linear, constant-velocity motion. For more complex motion, a regularization image such as that expressed by Equation (20) should be employed.

Although particular embodiments have been described above, those of skill in the art will appreciate that variations and modifications may be made without departing from the spirit and scope thereof as defined by the appended claims.

What is claimed is:

1. A method of reducing motion blur in a motion blurred image comprising:
blurring a guess image based on the motion blurred image as a function of blur parameters of the motion blurred image;
comparing the blurred guess image with the motion blurred image and generating an error image;
blurring the error image;
weighting pixels in the blurred error image based on the steepness of edges proximal to corresponding pixels in the motion blurred image; and
combining the blurred and weighted error image and the guess image thereby to update the guess image and correct for motion blur.

2. The method of claim 1, wherein the weighting comprises:
constructing a weighting image having pixel values that are based on the steepness of edges proximal to corresponding pixels in the motion blurred image; and
combining the weighting image with the blurred error image.

3. The method of claim 2, wherein the weighting image constructing comprises for each pixel in the motion blurred image:
identifying a neighborhood of pixels;
calculating a luminance gradient of pixels within each neighborhood; and
normalizing each luminance gradient with respect to its neighborhood;
wherein each pixel in the weighting image represents the normalized luminance gradient corresponding to each pixel in the motion blurred image.

4. The method of claim 3, comprising:
after the normalizing, scaling each pixel in the weighting image by a maximum step size value.

5. The method of claim 4, wherein the maximum step size value is based on the blur parameters.

6. The method of claim 3, wherein the neighborhood is based on the blur parameters.

7. The method of claim 6, wherein the neighborhood comprises a set of pixels along a motion path traversed by an image capture device used to capture the motion blurred image.

8. The method of claim 7, wherein the neighborhood is represented by a straight line having a length and direction corresponding to an extent and direction of blur in the motion blurred image.

9. The method of claim 3, wherein the luminance gradient calculating comprises:
calculating the difference between maximum and minimum pixel luminances within the neighborhood;
wherein normalizing each luminance gradient comprises dividing each luminance gradient by its respective maximum pixel luminance.

10. The method of claim 9, wherein:
the maximum pixel luminance is obtained using a morphological dilation operation within the neighborhood; and
the minimum pixel luminance is obtained using a morphological erosion operation within the neighborhood.

11. The method of claim 1, further comprising:
forming a regularization image based on edges in the guess image;
wherein the updated guess image is generated by combining the regularization image, the blurred and weighted error image and the guess image.

12. The method of claim 11, wherein the regularization image forming comprises:
constructing horizontal and vertical edge images from the guess image; and
summing the horizontal and vertical edge images thereby to form the regularization image.

13. The method of claim 11 wherein the guess image blurring, comparing, error image blurring, weighting and combining are performed iteratively.

14. The method of claim 13 wherein the guess image blurring, comparing, error image blurring, weighting and combining are performed iteratively a threshold number of times.

15. The method of claim 1 wherein the guess image is the motion blurred image.

16. An apparatus for reducing motion blur in a motion blurred image, the apparatus comprising:
a guess image blurring module blurring a guess image based on the motion blurred image as a function of blur parameters of the motion blurred image;
a comparator comparing the blurred guess image with the motion blurred image and generating an error image;
an error image blurring module blurring the error image;
a weighting module weighting pixels in the blurred error image based on the steepness of edges proximal to corresponding pixels in the motion blurred image; and
an image combiner combining the blurred and weighted error image and the guess image thereby to update the guess image and correct for motion blur.

17. The apparatus of claim 16, wherein the weighting module comprises:
a weighting image module constructing a weighting image having pixel values that are based on the steepness of edges proximal to corresponding pixels in the motion blurred image;
wherein the image combiner combines the weighting image with the blurred error image.

18. The apparatus of claim 17, wherein the weighting image module comprises:
a neighborhood definer identifying a neighborhood of pixels for each pixel in the motion blurred image;
a gradient calculator calculating a luminance gradient of pixels within each neighborhood and normalizing each luminance gradient with respect to its neighborhood; and
an image builder defining each pixel in the weighting image to represent the normalized luminance gradient corresponding to each pixel in the motion blurred image.

19. The apparatus of claim 18, wherein after the normalizing the image builder scales each pixel in the weighting image by a maximum step size value.

20. The apparatus of claim 19, wherein the maximum step size value is based on the blur parameters.

21. The apparatus of claim 18, wherein the neighborhood definer defines the neighborhood based on the blur parameters.

22. The apparatus of claim 21, wherein the neighborhood comprises a set of pixels along a motion path traversed by an image capture device used to capture the motion blurred image.

23. The apparatus of claim 22, wherein the neighborhood is represented by a straight line having a length and direction corresponding to an extent and direction of blur in the motion blurred image.

24. The apparatus of claim 18, wherein during luminance gradient calculating and normalizing the gradient calculator calculates a difference between maximum and minimum pixel luminances within the neighborhood and divides each luminance gradient by its respective maximum pixel luminance.

25. The apparatus of claim 24, wherein the gradient calculator conducts a morphological dilation operation within the neighborhood to obtain the maximum pixel luminance, and conducts a morphological erosion operation within the neighborhood to obtain the minimum pixel luminance.

26. The apparatus of claim 16, further comprising:
a regularization module forming a regularization image based on edges in the guess image;
wherein the updated guess image is generated by combining the regularization image, the blurred and weighted error image and the guess image.

27. The apparatus of claim 26 wherein the guess image blurring, comparing, error image blurring, weighting, and combining are performed iteratively.

28. A computer readable medium embodying a computer program for reducing motion blur in a motion blurred image, the computer program comprising:
computer program code blurring a guess image based on the motion blurred image as a function of blur parameters of the motion blurred image;
computer program code comparing the blurred guess image with the motion blurred image and generating an error image;
computer program code blurring the error image;
computer program code weighting pixels in the blurred error image based on the steepness of edges proximal to corresponding pixels in the motion blurred image; and
computer program code combining the blurred and weighted error image and the guess image thereby to update the guess image and correct for motion blur.
